(19) United States
(12) Patent Application Publication
(10) Pub. No.: US 2026/0260813 A1
(43) Pub. Date: Sep. 3, 2026

(54) ELECTRONIC COMPONENT

(71) Applicant: TDK Corporation, Tokyo (JP)

(72) Inventors: Toshio SAKURAI, Tokyo (JP); Masahide ISHIZUYA, Tokyo (JP); Makoto ISHIZAKI, Tokyo (JP); Asuka MURAKAMI, Tokyo (JP)

(73) Assignee: TDK Corporation, Tokyo (JP)

(21) Appl. No.: 19/546,518

(22) Filed: Feb. 23, 2026

(30) Foreign Application Priority Data
Feb. 28, 2025 (JP) 2025-031231

(51) Int. Cl. H01G 4/232; H01G 4/30

(52) U.S. Cl. CPC H01G 4/2325; H01G 4/30

(57) ABSTRACT

An electronic component includes an element body including a side surface, an internal conductor disposed in the element body, and an external conductor disposed on the side surface and connected to the internal conductor. The external conductor includes a base electrode layer, a first plating layer located on the base electrode layer and including Cu, a second plating layer located on the first plating layer and including any one metal selected from the group consisting of Sn, In, Zn, Au, Ag, Cr, Mn, Fe, and Co, and a third plating layer located on the second plating layer and including Ni.

### CROSS-REFERENCE TO RELATED APPLICATIONS

This application is based upon and claims the benefit of priority from Japanese Patent Application No. 2025-031231, filed on February 28, 2025, the entire contents of which are incorporated herein by reference.

### BACKGROUND

### Field

One aspect of the present disclosure relates to an electronic component.

### Description of the Related Art

Known electronic components include an element body including a side surface, an internal conductor disposed in the element body, and an external conductor disposed on the side surface and connected to the internal conductor (see, for example, Japanese Unexamined Patent Publication No. 2003-243249). The external conductor includes a base electrode layer and a plating layer that is located on the base electrode layer and includes Ni.

### SUMMARY

An electronic component according to one aspect of the present disclosure includes an element body including a side surface, an internal conductor disposed in the element body, and an external conductor disposed on the side surface and connected to the internal conductor. The external conductor includes a base electrode layer, a first plating layer located on the base electrode layer and including Cu, a second plating layer located on the first plating layer and including any one metal selected from the group consisting of Sn, In, Zn, Au, Ag, Cr, Mn, Fe, and Co, and a third plating layer located on the second plating layer and including Ni.

### BRIEF DESCRIPTION OF THE DRAWINGS

FIG. 1 is a perspective view of a multilayer capacitor according to an example;

FIG. 2 is a diagram illustrating a cross-sectional configuration of the multilayer capacitor according to the example;

FIG. 3 is a table illustrating test results for each sample; and

FIG. 4 is a table illustrating test results for each sample.

### DETAILED DESCRIPTION

In the following description, with reference to the drawings, the same reference numbers are assigned to the same components or to similar components having the same function, and overlapping description is omitted.

One aspect of the present disclosure provides an electronic component that suppresses a decrease in insulation resistance.

In a configuration in which the external conductor includes a plating layer including Ni, hydrogen generated during the process of forming the plating layer including Ni may remain in the plating layer including Ni, as recognized by the present inventor. Hydrogen remaining in the plating layer including Ni may diffuse into the element body after diffusing through the base electrode layer. Hydrogen that has diffused into the element body may decrease the insulation resistance of the electronic component.

One aspect of the present disclosure relates to an electronic component that includes an element body including a side surface, an internal conductor disposed in the element body, and an external conductor disposed on the side surface and connected to the internal conductor. The external conductor includes a base electrode layer, a first plating layer located on the base electrode layer and including Cu, a second plating layer located on the first plating layer and including any one metal selected from the group consisting of Sn, In, Zn, Au, Ag, Cr, Mn, Fe, and Co, and a third plating layer located on the second plating layer and including Ni.

In the one aspect described above, the first plating layer and the second plating layer are located between the base electrode layer and the third plating layer, the first plating layer including Cu, the second plating layer including any one metal selected from the group consisting of Sn, In, Zn, Au, Ag, Cr, Mn, Fe, and Co. Therefore, the first plating layer and the second plating layer suppress the diffusion of hydrogen from the third plating layer to the base electrode layer. Consequently, the one aspect described above suppresses a decrease in insulation resistance.

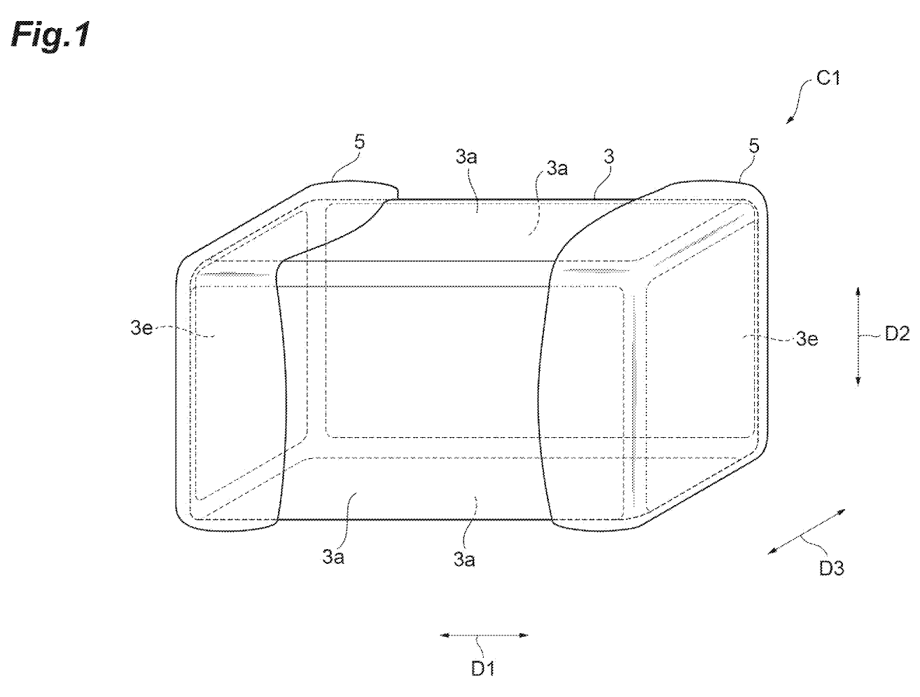

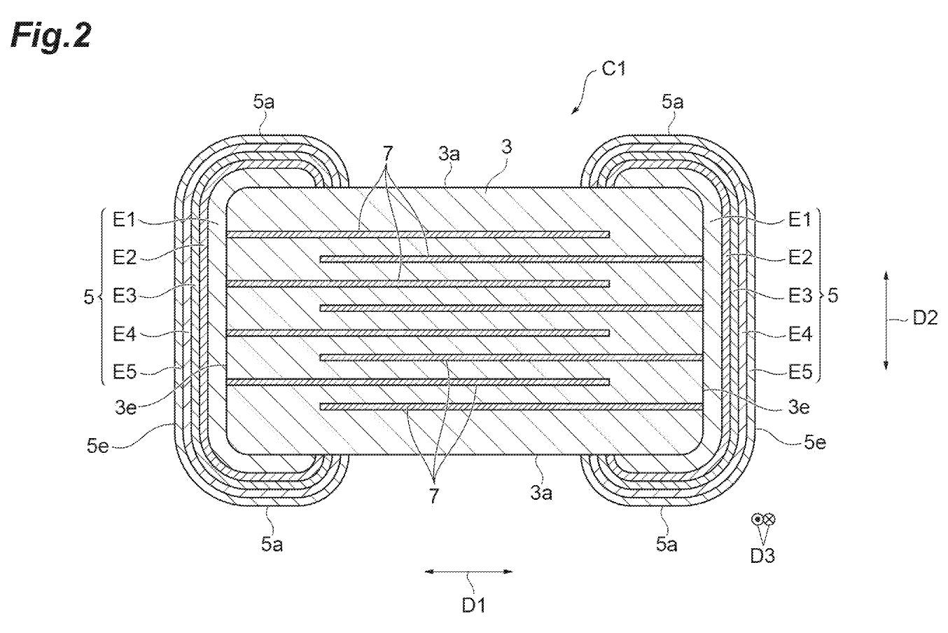

A configuration of a multilayer capacitor C1 according to an example will be described with reference to FIG. 1 and FIG. 2. FIG. 1 is a perspective view of a multilayer capacitor according to an example. FIG. 2 is a diagram illustrating a cross-sectional configuration of the multilayer capacitor according to the example.

An electronic component includes, for example, the multilayer capacitor C1.

As illustrated in FIG. 1, the multilayer capacitor C1 includes an element body 3 having a rectangular parallelepiped shape, and a plurality of external electrodes 5. The multilayer capacitor C1 includes, for example, a pair of external electrodes 5. The pair of external electrodes 5 are disposed on a surface of the element body 3. The pair of external electrodes 5 are separated from each other. The rectangular parallelepiped shape includes, for example, a rectangular parallelepiped shape in which corners and ridges are chamfered, or a rectangular parallelepiped shape in which corners and ridges are rounded.

The element body 3 includes four side surfaces 3a and a pair of side surfaces 3e opposing each other. The four side surfaces 3a and the pair of side surfaces 3e have a rectangular shape. The four side surfaces 3a include a first pair of side surfaces 3a opposing each other and a second pair of side surfaces 3a opposing each other. A direction in which the first pair of side surfaces 3a oppose each other is a direction D2. A direction in which the second pair of side surfaces 3a oppose each other is a direction D3. A direction in which the pair of side surfaces 3e oppose each other is a direction D1. The side surface 3e includes a side surface of the element body 3.

The multilayer capacitor C1 is, for example, solder-mounted on an electronic device. The electronic device includes, for example, a circuit board or another electronic component. In the multilayer capacitor C1, one side surface 3a among the four side surfaces 3a opposes the electronic device. The one side surface 3a is arranged to constitute a mounting surface. The one side surface 3a includes the mounting surface.

The direction D2 includes a direction perpendicular to the first pair of side surfaces 3a and is perpendicular to the direction D3. The direction D1 includes a direction parallel to the first pair of side surfaces 3a and the second pair of side surfaces 3a, and is perpendicular to the direction D2 and the direction D3. The direction D3 includes a direction perpendicular to the second pair of side surfaces 3a, and the direction D1 includes a direction perpendicular to the pair of side surfaces 3e. A length of the element body 3 in the direction D1 is, for example, larger than a length of the element body 3 in the direction D2 and larger than a length of the element body 3 in the direction D3. The direction D1 includes a longitudinal direction of the element body 3. The length of the element body 3 in the direction D2 and the length of the element body 3 in the direction D3 may be equal to each other. The length of the element body 3 in the direction D2 and the length of the element body 3 in the direction D3 may be different from each other.

The length of the element body 3 in the direction D2 includes the height of the element body 3. The length of the element body 3 in the direction D3 includes the width of the element body 3. The length of the element body 3 in the direction D1 includes the length of the element body 3 in the longitudinal direction. For example, the height of the element body 3 is from 0.1 to 3.2 mm, the width of the element body 3 is from 0.1 to 6.3 mm, and the length of the element body 3 is from 0.2 to 7.5 mm. For example, the height of the element body 3 is 0.33 mm, the width of the element body 3 is 0.30 mm, and the length of the element body 3 is 0.60 mm.

The first pair of side surfaces 3a extend in the direction D3 to couple the second pair of side surfaces 3a. The first pair of side surfaces 3a extend in the direction D1. The second pair of side surfaces 3a extend in the direction D2 to couple the first pair of side surfaces 3a. The second pair of side surfaces 3a extend in the direction D1. The pair of side surfaces 3e extend in the direction D2 to couple the first pair of side surfaces 3a. The pair of side surfaces 3e extend in the direction D3 to couple the second pair of side surfaces 3a.

The element body 3 includes, for example, a first ridge portion located between the side surface 3e and the side surface 3a, and a second ridge portion located between one of the first pair of side surfaces 3a and one of the second pair of side surfaces 3a. For example, the first ridge portion and the second ridge portion are rounded to be curved. For example, the element body 3 is subjected to what is so-called a round chamfering process. The side surface 3e and the side surface 3a are indirectly adjacent to each other with the first ridge portion between the side surface 3e and the side surface 3a. One of the first pair of side surfaces 3a and one of the second pair of side surfaces 3a are indirectly adjacent to each other with the second ridge portion between the one of the first pair of side surfaces 3a and the one of the second pair of side surfaces 3a.

The element body 3 is configured through laminating a plurality of dielectric layers in the direction D2. The element body 3 includes a plurality of laminated dielectric layers. In the element body 3, a lamination direction of the plurality of dielectric layers coincides with the direction D2. For example, each dielectric layer includes a sintered body of a ceramic green sheet containing a dielectric material. Examples of the dielectric material include dielectric ceramics. Examples of the dielectric ceramics include BaTiO₃-based, Ba(Ti, Zr)O₃-based, or (Ba, Ca)TiO₃-based dielectric ceramics. In the actual element body 3, each of the dielectric layers is integrated to such an extent that a boundary between the dielectric layers cannot be visually recognized. In the element body 3, the lamination direction of the plurality of dielectric layers may coincide with the direction D3.

As illustrated in FIG. 2, the multilayer capacitor C1 includes a plurality of internal electrodes 7. Each internal electrode 7 includes an internal conductor disposed in the element body 3. Each internal electrode 7 is made of an electrically conductive material that is commonly used as an internal conductor of a multilayer electronic component. The electrically conductive material includes, for example, a base metal. The electrically conductive material includes, for example, nickel (Ni) or copper (Cu). The internal electrode 7 is configured as a sintered body of an electrically conductive paste containing the electrically conductive material described above. For example, the internal electrode 7 is made of Ni. The internal electrode 7 includes, for example, Ni.

The plurality of internal electrodes 7 are disposed in different positions (layers) in the direction D2. The plurality of internal electrodes 7 are disposed in the element body 3 to oppose each other with an interval therebetween in the direction D2. The internal electrodes 7 adjacent in the direction D2 have different polarities from each other. One end of the internal electrode 7 is exposed at a corresponding side surface 3e of the pair of side surfaces 3e. The internal electrode 7 includes one end exposed at the corresponding side surface 3e. The plurality of internal electrodes 7 include an internal electrode 7 exposed at one side surface 3e of the pair of side surfaces 3e, and an internal electrode 7 exposed at the other side surface 3e of the pair of side surfaces 3e. The internal electrode 7 exposed at the one side surface 3e and the internal electrode 7 exposed at the other side surface 3e are alternately disposed in the direction D2. The plurality of internal electrodes 7 are disposed in the element body 3 to be distributed in the direction D2. The internal electrode 7 is located in a plane substantially parallel to the first pair of side surfaces 3a. A direction in which the internal electrodes 7 oppose each other is perpendicular to a direction parallel to the first pair of side surfaces 3a.

In a configuration in which the lamination direction of the plurality of dielectric layers includes the direction D3, the plurality of internal electrodes 7 are disposed in different positions (layers) in the direction D3. In this configuration, the internal electrodes 7 exposed at the one side surface 3e and the internal electrodes 7 exposed at the other side surface 3e are alternately disposed in the direction D3. The internal electrode 7 is located in a plane substantially parallel to the second pair of side surfaces 3a. The internal electrodes 7 oppose each other in the direction D3.

As illustrated in FIG. 1 and FIG. 2, the external electrodes 5 are disposed at both ends of the element body 3 in the direction D1. Each external electrode 5 is disposed on a corresponding side surface 3e of the element body 3. Each external electrode 5 includes an external conductor disposed on the corresponding side surface 3e. For example, each external electrode 5 is disposed on the four side surfaces 3a and one side surface 3e. The external electrode 5 includes a plurality of electrode portions 5a and 5e. The electrode portion 5a is located on the side surface 3a. The electrode portion 5a may be located on a ridge portion between the side surface 3a and the side surface 3e. The electrode portion 5e is located on the side surface 3e. The external electrode 5 includes an electrode portion located on a ridge portion between adjacent side surfaces 3a. For example, where the ridge portion between the side surface 3a and the side surface 3e includes a first ridge portion, the ridge portion between adjacent side surfaces 3a includes the second ridge portion.

The external electrode 5 is formed on five surfaces of the four side surfaces 3a and the side surface 3e. The electrode portions 5a and 5e adjacent to each other are physically coupled and electrically connected to each other. The electrode portion 5e covers the entire one end of a corresponding internal electrode 7 among the plurality of internal electrodes 7. The electrode portion 5e is directly connected to the corresponding internal electrode 7. The external electrode 5 is electrically connected to the corresponding internal electrode 7.

As illustrated in FIG. 2, the external electrode 5 includes a first electrode layer E1, a second electrode layer E2, a third electrode layer E3, a fourth electrode layer E4, and a fifth electrode layer E5. For example, the fifth electrode layer E5 includes the outermost layer of the external electrode 5. Each of the electrode portions 5a and 5e includes the first electrode layer E1, the second electrode layer E2, the third electrode layer E3, the fourth electrode layer E4, and the fifth electrode layer E5.

The first electrode layer E1 of the electrode portion 5a is disposed on the side surface 3a. The first electrode layer E1 of the electrode portion 5a covers a partial region of the side surface 3a. The first electrode layer E1 of the electrode portion 5a is in contact with the partial region of the side surface 3a. The side surface 3a is exposed from the first electrode layer E1 except for the partial region covered by the first electrode layer E1. The partial region covered by the first electrode layer E1 of the electrode portion 5a is located closer to the side surface 3e.

The second electrode layer E2 of the electrode portion 5a is disposed on the first electrode layer E1. In the electrode portion 5a, the second electrode layer E2 entirely covers the first electrode layer E1. In the electrode portion 5a, the second electrode layer E2 indirectly covers the partial region of the side surface 3a such that the first electrode layer E1 is located between the second electrode layer E2 and the element body 3. The second electrode layer E2 of the electrode portion 5a is located on the side surface 3a. In the electrode portion 5a, the second electrode layer E2 is located on the first electrode layer E1. For example, in the electrode portion 5a, the second electrode layer E2 is in contact with the first electrode layer E1.

The third electrode layer E3 of the electrode portion 5a is disposed on the second electrode layer E2. In the electrode portion 5a, the third electrode layer E3 entirely covers the second electrode layer E2. In the electrode portion 5a, the third electrode layer E3 indirectly covers the first electrode layer E1 such that the second electrode layer E2 is located between the third electrode layer E3 and the first electrode layer E1. In the electrode portion 5a, the third electrode layer E3 is not in contact with the first electrode layer E1. The third electrode layer E3 of the electrode portion 5a is located on the side surface 3a. In the electrode portion 5a, the third electrode layer E3 is located on the second electrode layer E2. For example, in the electrode portion 5a, the third electrode layer E3 is in contact with the second electrode layer E2.

The fourth electrode layer E4 of the electrode portion 5a is disposed on the third electrode layer E3. In the electrode portion 5a, the fourth electrode layer E4 entirely covers the third electrode layer E3. In the electrode portion 5a, the fourth electrode layer E4 indirectly covers the second electrode layer E2 such that the third electrode layer E3 is located between the fourth electrode layer E4 and the second electrode layer E2. In the electrode portion 5a, the fourth electrode layer E4 is not in contact with the second electrode layer E2. The fourth electrode layer E4 of the electrode portion 5a is located on the side surface 3a. In the electrode portion 5a, the fourth electrode layer E4 is located on the third electrode layer E3. For example, in the electrode portion 5a, the fourth electrode layer E4 is in contact with the third electrode layer E3.

The fifth electrode layer E5 of the electrode portion 5a is disposed on the fourth electrode layer E4. In the electrode portion 5a, the fifth electrode layer E5 entirely covers the fourth electrode layer E4. In the electrode portion 5a, the fifth electrode layer E5 indirectly covers the third electrode layer E3 such that the fourth electrode layer E4 is located between the fifth electrode layer E5 and the third electrode layer E3. In the electrode portion 5a, the fifth electrode layer E5 is not in contact with the third electrode layer E3. The fifth electrode layer E5 of the electrode portion 5a is located on the side surface 3a. In the electrode portion 5a, the fifth electrode layer E5 is located on the fourth electrode layer E4. For example, in the electrode portion 5a, the fifth electrode layer E5 is in contact with the fourth electrode layer E4.

In the electrode portion 5a, the second electrode layer E2, the third electrode layer E3, the fourth electrode layer E4, and the fifth electrode layer E5 are located outside the first electrode layer E1.

The first electrode layer E1 of the electrode portion 5e is disposed on the side surface 3e. The first electrode layer E1 of the electrode portion 5e entirely covers the side surface 3e. The first electrode layer E1 of the electrode portion 5e is in contact with the side surface 3e. The first electrode layer E1 of the electrode portion 5e is connected to the one end of the corresponding internal electrode 7.

The second electrode layer E2 of the electrode portion 5e is disposed on the first electrode layer E1. In the electrode portion 5e, the second electrode layer E2 entirely covers the first electrode layer E1. In the electrode portion 5e, the second electrode layer E2 indirectly covers the side surface 3e such that the first electrode layer E1 is located between the second electrode layer E2 and the side surface 3e. The second electrode layer E2 of the electrode portion 5e is located on the side surface 3e. In the electrode portion 5e, the second electrode layer E2 is located on the first electrode layer E1. For example, in the electrode portion 5e, the second electrode layer E2 is in contact with the first electrode layer E1.

The third electrode layer E3 of the electrode portion 5e is disposed on the second electrode layer E2. In the electrode portion 5e, the third electrode layer E3 entirely covers the second electrode layer E2. In the electrode portion 5e, the third electrode layer E3 indirectly covers the first electrode layer E1 such that the second electrode layer E2 is located between the third electrode layer E3 and the first electrode layer E1. In the electrode portion 5e, the third electrode layer E3 is not in contact with the first electrode layer E1. The third electrode layer E3 of the electrode portion 5e is located on the side surface 3e. In the electrode portion 5e, the third electrode layer E3 is located on the second electrode layer E2. For example, in the electrode portion 5e, the third electrode layer E3 is in contact with the second electrode layer E2.

The fourth electrode layer E4 of the electrode portion 5e is disposed on the third electrode layer E3. In the electrode portion 5e, the fourth electrode layer E4 entirely covers the third electrode layer E3. In the electrode portion 5e, the fourth electrode layer E4 indirectly covers the second electrode layer E2 such that the third electrode layer E3 is located between the fourth electrode layer E4 and the second electrode layer E2. In the electrode portion 5e, the fourth electrode layer E4 is not in contact with the second electrode layer E2. The fourth electrode layer E4 of the electrode portion 5e is located on the side surface 3e. In the electrode portion 5e, the fourth electrode layer E4 is located on the third electrode layer E3. For example, in the electrode portion 5e, the fourth electrode layer E4 is in contact with the third electrode layer E3.

The fifth electrode layer E5 of the electrode portion 5e is disposed on the fourth electrode layer E4. In the electrode portion 5e, the fifth electrode layer E5 entirely covers the fourth electrode layer E4. In the electrode portion 5e, the fifth electrode layer E5 indirectly covers the third electrode layer E3 such that the fourth electrode layer E4 is located between the fifth electrode layer E5 and the third electrode layer E3. In the electrode portion 5e, the fifth electrode layer E5 is not in contact with the third electrode layer E3. The fifth electrode layer E5 of the electrode portion 5e is located on the side surface 3e. In the electrode portion 5e, the fifth electrode layer E5 is located on the fourth electrode layer E4. For example, in the electrode portion 5e, the fifth electrode layer E5 is in contact with the fourth electrode layer E4.

In the electrode portion 5e, the second electrode layer E2, the third electrode layer E3, the fourth electrode layer E4, and the fifth electrode layer E5 are located outside the first electrode layer E1.

The first electrode layer E1 is formed, for example, through sintering an electrically conductive paste applied onto the surface of the element body 3. The electrically conductive paste is applied onto the partial region of the side surface 3a and the side surface 3e. The first electrode layer E1 is formed to cover each partial region of the four side surfaces 3a and the side surface 3e. The first electrode layer E1 is formed through sintering a metal component (metal powder) included in the electrically conductive paste. The first electrode layer E1 includes, for example, a sintered metal layer. The first electrode layer E1 includes, for example, a sintered metal layer formed on the element body 3. The first electrode layer E1 includes, for example, a sintered metal layer made of Cu. The first electrode layer E1 may include a sintered metal layer made of Ni. The first electrode layer E1 may include a base metal. The electrically conductive paste may include, for example, particles made of Cu or Ni, a glass component, an organic binder, and an organic solvent. The first electrode layers E1 included in the electrode portions 5a and 5e are, for example, formed integrally with each other. The first electrode layer E1 has a thickness of, for example, from 5 to 20 μm.

The second electrode layer E2 is formed on the first electrode layer E1 through a Cu plating process. The first electrode layer E1 includes a base electrode layer for forming a plating layer. The second electrode layer E2 includes Cu. The second electrode layer E2 may include a trace amount of unavoidable impurities. The second electrode layer E2 includes a Cu plating layer. The Cu plating process includes an electrolytic Cu plating process. The second electrode layer E2 includes an electrolytic Cu plating layer. The second electrode layer E2 has a thickness of 0.5 μm or more. The second electrode layer E2 may have a thickness of 4.5 μm or less. The second electrode layer E2 may include from 0.1 to 0.5 mol% of S (sulfur). That is, S (sulfur) may be included in an amount of from 0.1 to 0.5 mol relative to 100 mol of the metal component included in the second electrode layer E2.

The third electrode layer E3 is formed on the second electrode layer E2 through a plating process. The third electrode layer E3 includes, for example, a metal plating layer. The plating process includes an electrolytic plating process. The third electrode layer E3 includes an electrolytic plating layer. The third electrode layer E3 includes any one metal selected from the group consisting of Sn, In, Zn, Au, Ag, Cr, Mn, Fe, and Co. The third electrode layer E3 may include a trace amount of unavoidable impurities. The metal included in the third electrode layer E3 may be substantially only any one metal selected from the group consisting of Sn, In, Zn, Au, Ag, Cr, Mn, Fe, and Co. For example, the third electrode layer E3 includes Sn. For example, the third electrode layer E3 includes an Sn plating layer. The third electrode layer E3 has a thickness of 0.5 μm or more. The third electrode layer E3 may have a thickness of 4.5 μm or less. The third electrode layer E3 may include from 0.1 to 0.5 mol% of S (sulfur). That is, S (sulfur) may be included in an amount of from 0.1 to 0.5 mol relative to 100 mol of the metal component included in the third electrode layer E3.

The fourth electrode layer E4 is formed on the third electrode layer E3 through an Ni plating process. The fourth electrode layer E4 includes Ni. The fourth electrode layer E4 includes an Ni plating layer. The Ni plating process includes an electrolytic Ni plating process. The fourth electrode layer E4 includes an electrolytic Ni plating layer. The fourth electrode layer E4 tends to have better solder leaching resistance than the metals included in the first electrode layer E1 and the second electrode layer E2. The fourth electrode layer E4 has a thickness of, for example, from 2 to 8 μm. For example, where the second electrode layer E2 includes a first plating layer, the third electrode layer E3 includes a second plating layer, and the fourth electrode layer E4 includes a third plating layer.

The fifth electrode layer E5 is formed on the fourth electrode layer E4 through a plating process. The fifth electrode layer E5 includes, for example, a solder plating layer. The plating process includes an electrolytic solder plating process. The fifth electrode layer E5 includes an electrolytic solder plating layer. The solder plating layer includes, for example, an Sn plating layer. In a configuration in which the solder plating layer includes an Sn plating layer, the fifth electrode layer E5 includes Sn. The fifth electrode layer E5 may include an Sn-Ag alloy plating layer, an Sn-Bi alloy plating layer, or an Sn-Cu alloy plating layer instead of the Sn plating layer. The solder plating layer tends to have good solderability. The fifth electrode layer E5 has a thickness of, for example, from 4 to 8 μm.

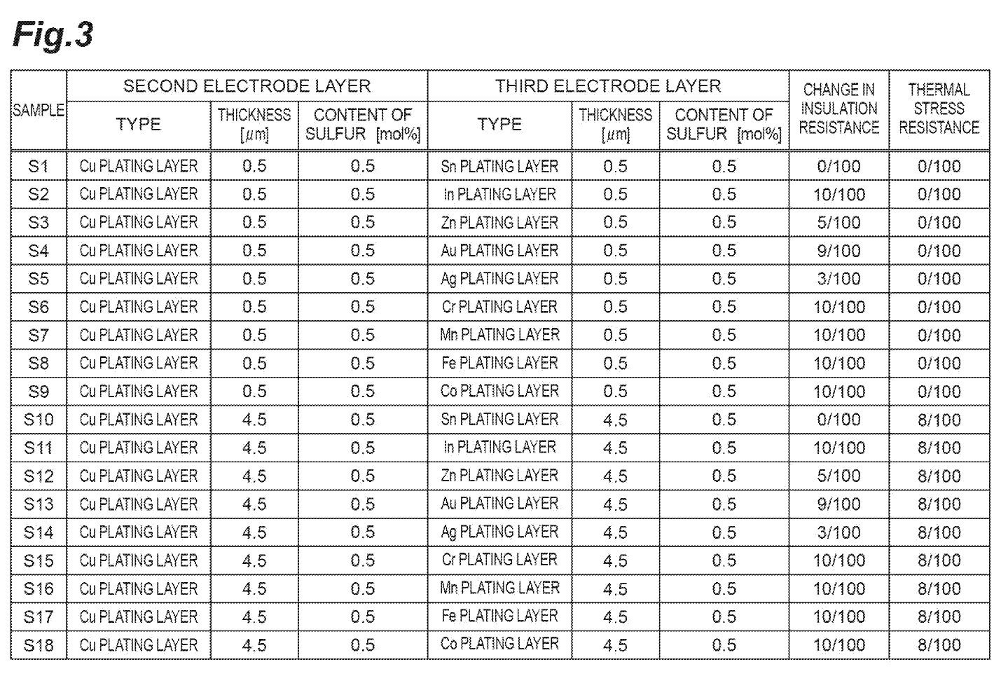

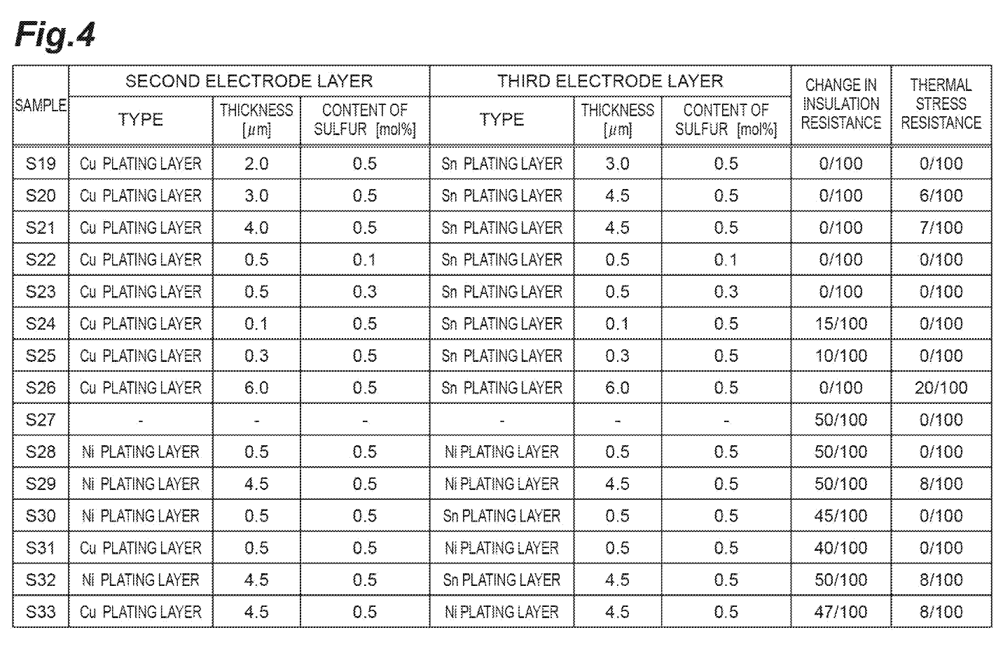

The present inventors conducted the following tests to confirm that the multilayer capacitor C1 described above suppresses a decrease in insulation resistance. In these tests, the present inventors prepared samples S1 to S33 with different configurations of the second electrode layer E2 and the third electrode layer E3, and confirmed the change in insulation resistance and the thermal stress resistance in each of the samples S1 to S33. The results of the tests are presented in FIG. 3 and FIG. 4. FIG. 3 and FIG. 4 are tables illustrating test results for each sample.

Each of the samples S1 to S33 is a lot including a plurality of specimens. The specimens of each of the samples S1 to S33 are multilayer capacitors having the same configuration, except that the type of metal plating layer in the second electrode layer E2, the thicknesses of the second electrode layer E2 and the third electrode layer E3, and the content of S (sulfur) in the second electrode layer E2 and the third electrode layer E3 are different. In the specimens of samples S1 to S33, the height of the element body 3 is 0.33 mm, the width of the element body 3 is 0.30 mm, and the length of the element body 3 is 0.60 mm. In each specimen, the capacitance is 1.0 μF, and the insulation resistance value is 1.0×10⁹ Ω.

In sample S1, the second electrode layer E2 (Cu plating layer) has a thickness of 0.5 μm, and the third electrode layer E3 includes a Sn plating layer and has a thickness of 0.5 μm. The content of S (sulfur) in the second electrode layer E2 is 0.5 mol%. The content of S (sulfur) in the third electrode layer E3 is 0.5 mol%.

In sample S2, the second electrode layer E2 (Cu plating layer) has a thickness of 0.5 μm, and the third electrode layer E3 includes an In plating layer and has a thickness of 0.5 μm. The content of S (sulfur) in the second electrode layer E2 is 0.5 mol%. The content of S (sulfur) in the third electrode layer E3 is 0.5 mol%.

In sample S3, the second electrode layer E2 (Cu plating layer) has a thickness of 0.5 μm, and the third electrode layer E3 includes a Zn plating layer and has a thickness of 0.5 μm. The content of S (sulfur) in the second electrode layer E2 is 0.5 mol%. The content of S (sulfur) in the third electrode layer E3 is 0.5 mol%.

In sample S4, the second electrode layer E2 (Cu plating layer) has a thickness of 0.5 μm, and the third electrode layer E3 includes an Au plating layer and has a thickness of 0.5 μm. The content of S (sulfur) in the second electrode layer E2 is 0.5 mol%. The content of S (sulfur) in the third electrode layer E3 is 0.5 mol%.

In sample S5, the second electrode layer E2 (Cu plating layer) has a thickness of 0.5 μm, and the third electrode layer E3 includes an Ag plating layer and has a thickness of 0.5 μm. The content of S (sulfur) in the second electrode layer E2 is 0.5 mol%. The content of S (sulfur) in the third electrode layer E3 is 0.5 mol%.

In sample S6, the second electrode layer E2 (Cu plating layer) has a thickness of 0.5 μm, and the third electrode layer E3 includes a Cr plating layer and has a thickness of 0.5 μm. The content of S (sulfur) in the second electrode layer E2 is 0.5 mol%. The content of S (sulfur) in the third electrode layer E3 is 0.5 mol%.

In sample S7, the second electrode layer E2 (Cu plating layer) has a thickness of 0.5 μm, and the third electrode layer E3 includes a Mn plating layer and has a thickness of 0.5 μm. The content of S (sulfur) in the second electrode layer E2 is 0.5 mol%. The content of S (sulfur) in the third electrode layer E3 is 0.5 mol%.

In sample S8, the second electrode layer E2 (Cu plating layer) has a thickness of 0.5 μm, and the third electrode layer E3 includes a Fe plating layer and has a thickness of 0.5 μm. The content of S (sulfur) in the second electrode layer E2 is 0.5 mol%. The content of S (sulfur) in the third electrode layer E3 is 0.5 mol%.

In sample S9, the second electrode layer E2 (Cu plating layer) has a thickness of 0.5 μm, and the third electrode layer E3 includes a Co plating layer and has a thickness of 0.5 μm. The content of S (sulfur) in the second electrode layer E2 is 0.5 mol%. The content of S (sulfur) in the third electrode layer E3 is 0.5 mol%.

In sample S10, the second electrode layer E2 (Cu plating layer) has a thickness of 4.5 μm, and the third electrode layer E3 includes a Sn plating layer and has a thickness of 4.5 μm. The content of S (sulfur) in the second electrode layer E2 is 0.5 mol%. The content of S (sulfur) in the third electrode layer E3 is 0.5 mol%.

In sample S11, the second electrode layer E2 (Cu plating layer) has a thickness of 4.5 μm, and the third electrode layer E3 includes an In plating layer and has a thickness of 4.5 μm. The content of S (sulfur) in the second electrode layer E2 is 0.5 mol%. The content of S (sulfur) in the third electrode layer E3 is 0.5 mol%.

In sample S12, the second electrode layer E2 (Cu plating layer) has a thickness of 4.5 μm, and the third electrode layer E3 includes a Zn plating layer and has a thickness of 4.5 μm. The content of S (sulfur) in the second electrode layer E2 is 0.5 mol%. The content of S (sulfur) in the third electrode layer E3 is 0.5 mol%.

In sample S13, the second electrode layer E2 (Cu plating layer) has a thickness of 4.5 μm, and the third electrode layer E3 includes an Au plating layer and has a thickness of 4.5 μm. The content of S (sulfur) in the second electrode layer E2 is 0.5 mol%. The content of S (sulfur) in the third electrode layer E3 is 0.5 mol%.

In sample S14, the second electrode layer E2 (Cu plating layer) has a thickness of 4.5 μm, and the third electrode layer E3 includes an Ag plating layer and has a thickness of 4.5 μm. The content of S (sulfur) in the second electrode layer E2 is 0.5 mol%. The content of S (sulfur) in the third electrode layer E3 is 0.5 mol%.

In sample S15, the second electrode layer E2 (Cu plating layer) has a thickness of 4.5 μm, and the third electrode layer E3 includes a Cr plating layer and has a thickness of 4.5 μm. The content of S (sulfur) in the second electrode layer E2 is 0.5 mol%. The content of S (sulfur) in the third electrode layer E3 is 0.5 mol%.

In sample S16, the second electrode layer E2 (Cu plating layer) has a thickness of 4.5 μm, and the third electrode layer E3 includes a Mn plating layer and has a thickness of 4.5 μm. The content of S (sulfur) in the second electrode layer E2 is 0.5 mol%. The content of S (sulfur) in the third electrode layer E3 is 0.5 mol%.

In sample S17, the second electrode layer E2 (Cu plating layer) has a thickness of 4.5 μm, and the third electrode layer E3 includes a Fe plating layer and has a thickness of 4.5 μm. The content of S (sulfur) in the second electrode layer E2 is 0.5 mol%. The content of S (sulfur) in the third electrode layer E3 is 0.5 mol%.

In sample S18, the second electrode layer E2 (Cu plating layer) has a thickness of 4.5 μm, and the third electrode layer E3 includes a Co plating layer and has a thickness of 4.5 μm. The content of S (sulfur) in the second electrode layer E2 is 0.5 mol%. The content of S (sulfur) in the third electrode layer E3 is 0.5 mol%.

In sample S19, the second electrode layer E2 (Cu plating layer) has a thickness of 2.0 μm, and the third electrode layer E3 includes a Sn plating layer and has a thickness of 3.0 μm. The content of S (sulfur) in the second electrode layer E2 is 0.5 mol%. The content of S (sulfur) in the third electrode layer E3 is 0.5 mol%.

In sample S20, the second electrode layer E2 (Cu plating layer) has a thickness of 3.0 μm, and the third electrode layer E3 includes a Sn plating layer and has a thickness of 4.5 μm. The content of S (sulfur) in the second electrode layer E2 is 0.5 mol%. The content of S (sulfur) in the third electrode layer E3 is 0.5 mol%.

In sample S21, the second electrode layer E2 (Cu plating layer) has a thickness of 4.0 μm, and the third electrode layer E3 includes a Sn plating layer and has a thickness of 4.5 μm. The content of S (sulfur) in the second electrode layer E2 is 0.5 mol%. The content of S (sulfur) in the third electrode layer E3 is 0.5 mol%.

In sample S22, the second electrode layer E2 (Cu plating layer) has a thickness of 0.5 μm, and the third electrode layer E3 includes a Sn plating layer and has a thickness of 0.5 μm. The content of S (sulfur) in the second electrode layer E2 is 0.1 mol%. The content of S (sulfur) in the third electrode layer E3 is 0.1 mol%.

In sample S23, the second electrode layer E2 (Cu plating layer) has a thickness of 0.5 μm, and the third electrode layer E3 includes a Sn plating layer and has a thickness of 0.5 μm. The content of S (sulfur) in the second electrode layer E2 is 0.3 mol%. The content of S (sulfur) in the third electrode layer E3 is 0.3 mol%.

In sample S24, the second electrode layer E2 (Cu plating layer) has a thickness of 0.1 μm, and the third electrode layer E3 includes a Sn plating layer and has a thickness of 0.1 μm. The content of S (sulfur) in the second electrode layer E2 is 0.5 mol%. The content of S (sulfur) in the third electrode layer E3 is 0.5 mol%.

In sample S25, the second electrode layer E2 (Cu plating layer) has a thickness of 0.3 μm, and the third electrode layer E3 includes a Sn plating layer and has a thickness of 0.3 μm. The content of S (sulfur) in the second electrode layer E2 is 0.5 mol%. The content of S (sulfur) in the third electrode layer E3 is 0.5 mol%.

In sample S26, the second electrode layer E2 (Cu plating layer) has a thickness of 6.0 μm, and the third electrode layer E3 includes a Sn plating layer and has a thickness of 6.0 μm. The content of S (sulfur) in the second electrode layer E2 is 0.5 mol%. The content of S (sulfur) in the third electrode layer E3 is 0.5 mol%.

In sample S27, the external electrode 5 does not include the second electrode layer E2 and the third electrode layer E3. That is, the fourth electrode layer E4 is in contact with the first electrode layer E1.

In sample S28, the second electrode layer E2 includes a Ni plating layer and has a thickness of 0.5 μm. The third electrode layer E3 includes a Ni plating layer and has a thickness of 0.5 μm. The content of S (sulfur) in the second electrode layer E2 is 0.5 mol%. The content of S (sulfur) in the third electrode layer E3 is 0.5 mol%.

In sample S29, the second electrode layer E2 includes a Ni plating layer and has a thickness of 4.5 μm. The third electrode layer E3 includes a Ni plating layer and has a thickness of 4.5 μm. The content of S (sulfur) in the second electrode layer E2 is 0.5 mol%. The content of S (sulfur) in the third electrode layer E3 is 0.5 mol%.

In sample S30, the second electrode layer E2 includes a Ni plating layer and has a thickness of 0.5 μm. The third electrode layer E3 includes a Sn plating layer and has a thickness of 0.5 μm. The content of S (sulfur) in the second electrode layer E2 is 0.5 mol%. The content of S (sulfur) in the third electrode layer E3 is 0.5 mol%.

In sample S31, the second electrode layer E2 (Cu plating layer) has a thickness of 0.5 μm, and the third electrode layer E3 includes a Ni plating layer and has a thickness of 0.5 μm. The content of S (sulfur) in the second electrode layer E2 is 0.5 mol%. The content of S (sulfur) in the third electrode layer E3 is 0.5 mol%.

In sample S32, the second electrode layer E2 includes a Ni plating layer and has a thickness of 4.5 μm. The third electrode layer E3 includes a Sn plating layer and has a thickness of 4.5 μm. The content of S (sulfur) in the second electrode layer E2 is 0.5 mol%. The content of S (sulfur) in the third electrode layer E3 is 0.5 mol%.

In sample S33, the second electrode layer E2 (Cu plating layer) has a thickness of 4.5 μm, and the third electrode layer E3 includes a Ni plating layer and has a thickness of 4.5 μm. The content of S (sulfur) in the second electrode layer E2 is 0.5 mol%. The content of S (sulfur) in the third electrode layer E3 is 0.5 mol%.

The change in insulation resistance is confirmed from the results of a moisture resistance load test including the following procedure.

For each of samples S1 to S33, 100 specimens are selected, and the selected specimens are solder-mounted on a substrate (glass epoxy substrate). The substrate on which the specimens are mounted is placed in a constant temperature and humidity chamber, and a predetermined voltage is applied to the specimens mounted on the substrate for a predetermined time in an environment of 125°C and 95% relative humidity (RH). The predetermined voltage is set to 6.3 V, and the predetermined time is set to 168 hours. After the predetermined time described above has elapsed, the insulation resistance values of the specimens mounted on the substrate are measured. A specimen whose measured insulation resistance value is less than 1 MΩ is determined to be "defective". For each of samples S1 to S33, the number of specimens determined to be "defective" is counted. When the number of specimens determined to be "defective" out of 100 specimens is 15 or less, it is determined that the change in insulation resistance is suppressed.

The thermal stress resistance is confirmed from the results of a thermal stress test including the following procedure.

For each of samples S1 to S33, 100 specimens are selected, and the selected specimens are placed in a heating furnace and heat-treated for a predetermined time. The inside of the heating furnace is set to a nitrogen atmosphere, and the heat treatment temperature is set to 260°C. The predetermined time is set to 10 minutes. After the heat treatment, a visual inspection is performed, and a specimen in which the occurrence of cracks is confirmed is determined to be "defective". For each of samples S1 to S33, the number of specimens determined to be "defective" is counted. When the number of specimens determined to be "defective" out of 100 specimens is 10 or less, it is determined that the thermal stress resistance is good.

As a result of the test described above, as illustrated in FIG. 3 and FIG. 4, it was confirmed that in samples S1 to S26, the change in insulation resistance was suppressed, compared to samples S27 to S33. In samples S1, S10, S19 to S23, and S26, it was confirmed that the change in insulation resistance was further suppressed. In samples S3 and S5, although inferior to sample S1, it was confirmed that the change in insulation resistance was suppressed, compared to samples S2, S4, and S6 to S9.

In samples S1 to S23, it was confirmed that the thermal stress resistance was good, compared to sample S26. In samples S19 to S21, it was confirmed that the thermal stress resistance was good, compared to samples S10 to S18.

In the multilayer capacitor C1, the second electrode layer E2 and the third electrode layer E3 are located between the first electrode layer E1 and the fourth electrode layer E4. The second electrode layer E2 includes a plating layer including Cu. The third electrode layer E3 includes a plating layer including any one metal selected from the group consisting of Sn, In, Zn, Au, Ag, Cr, Mn, Fe, and Co. Therefore, the second electrode layer E2 and the third electrode layer E3 suppress the diffusion of hydrogen from the fourth electrode layer E4 to the first electrode layer E1. Consequently, the multilayer capacitor C1 suppresses a decrease in insulation resistance.

Each of the second electrode layer E2 and the third electrode layer E3 may have a thickness of 0.5 μm or more.

In a configuration in which each of the second electrode layer E2 and the third electrode layer E3 has a thickness of 0.5 μm or more, this configuration reliably suppresses the decrease in insulation resistance.

Each of the second electrode layer E2 and the third electrode layer E3 may have a thickness of 4.5 μm or less.

In a configuration in which each of the second electrode layer E2 and the third electrode layer E3 has a thickness of 4.5 μm or less, this configuration reduces the stress acting on the element body 3 from the second electrode layer E2 and the third electrode layer E3, even in an environment where thermal stress is applied. Therefore, this configuration suppresses the occurrence of cracks in the element body 3. This configuration suppresses a decrease in thermal stress resistance.

Based on the test results described above, it is presumed that the thermal stress resistance is affected by the thickness of the second electrode layer E2 and the third electrode layer E3. Therefore, even in a configuration in which the third electrode layer E3 includes a plating layer including any one metal selected from the group consisting of In, Zn, Au, Ag, Cr, Mn, Fe, and Co, other than Sn, it is presumed that the decrease in thermal stress resistance is suppressed.

The total thickness of the second electrode layer E2 and the third electrode layer E3 may be from 5.0 to 8.5 μm.

In a configuration in which the total thickness of the second electrode layer E2 and the third electrode layer E3 is from 5.0 to 8.5 μm, this configuration reliably suppresses the decrease in insulation resistance and the decrease in thermal stress resistance.

The ratio of the thickness of the second electrode layer E2 to the thickness of the third electrode layer E3 may be from 2/3 to 8/9.

In a configuration in which the ratio of the thickness of the second electrode layer E2 to the thickness of the third electrode layer E3 is from 2/3 to 8/9, this configuration reliably suppresses the decrease in insulation resistance and the decrease in thermal stress resistance.

The third electrode layer E3 may include a plating layer including Sn.

In a configuration in which the third electrode layer E3 includes a plating layer including Sn, this configuration further suppresses the decrease in insulation resistance.

Each of the second electrode layer E2 and the third electrode layer E3 may include from 0.1 to 0.5 mol% of S (sulfur).

Even in a configuration in which each of the second electrode layer E2 and the third electrode layer E3 includes from 0.1 to 0.5 mol% of S (sulfur), the decrease in insulation resistance is suppressed.

The multilayer capacitor C1 may include the fifth electrode layer E5.

The multilayer capacitor C1 including the fifth electrode layer E5 has good solderability.

Each of the second electrode layer E2 and the third electrode layer E3 may include an electrolytic plating layer.

An electrolytic plating layer tends to have high adhesion to a base material and high wear resistance. In contrast, an electroless plating layer tends to have low adhesion to a base material and low wear resistance. Therefore, the second electrode layer E2 and the third electrode layer E3 including an electrolytic plating layer tend to have high adhesion and high wear resistance of the second electrode layer E2 and the third electrode layer E3. That is, in the second electrode layer E2, the bonding property and durability of the second electrode layer E2 are improved, and in the third electrode layer E3, the bonding property and durability of the third electrode layer E3 are improved. Consequently, the second electrode layer E2 and the third electrode layer E3 further suppress the diffusion of hydrogen from the fourth electrode layer E4 to the first electrode layer E1. In a configuration in which the second electrode layer E2 and the third electrode layer E3 include an electrolytic plating layer, this configuration further suppresses the decrease in insulation resistance.

In the present specification, when an element is described as being disposed on another element, the element may be directly disposed on the other element or may be indirectly disposed on the other element. Where an element is indirectly disposed on another element, an intervening element is present between the element and the other element. Where an element is directly disposed on another element, no intervening element is present between the element and the other element.

In the present specification, when an element is described as being located on another element, the element may be directly located on the other element, or may be indirectly located on the other element. Where an element is indirectly located on another element, an intervening element is present between the element and the other element. Where an element is directly located on another element, no intervening element is present between the element and the other element.

In the present specification, when an element is described as covering another element, the element may directly cover the other element, or may indirectly cover the other element. Where an element indirectly covers another element, an intervening element is present between the element and the other element. Where an element directly covers another element, no intervening element is present between the element and the other element.

It is to be understood that not all aspects, advantages and features described herein may necessarily be achieved by, or included in, any one particular example. Indeed, having described and illustrated various examples herein, it should be apparent that other examples may be modified in arrangement and detail.

In the present example, the electronic component includes the multilayer capacitor. However, the applicable electronic component is not limited to the multilayer capacitor. For example, the applicable electronic component includes a multilayer electronic component such as a multilayer inductor, a multilayer varistor, a multilayer piezoelectric actuator, a multilayer thermistor, a multilayer solid-state battery component, or a multilayer composite component, or electronic components other than the multilayer electronic components.

What is claimed is:

1. An electronic component comprising:
an element body including a side surface;
an internal conductor disposed in the element body; and
an external conductor disposed on the side surface and connected to the internal conductor, wherein
the external conductor includes:
a base electrode layer;
a first plating layer located on the base electrode layer and including Cu;
a second plating layer located on the first plating layer and including any one metal selected from the group consisting of Sn, In, Zn, Au, Ag, Cr, Mn, Fe, and Co; and
a third plating layer located on the second plating layer and including Ni.

2. The electronic component according to claim 1, wherein
each of the first plating layer and the second plating layer has a thickness of 0.5 μm or more.

3. The electronic component according to claim 2, wherein
each of the first plating layer and the second plating layer has a thickness of 4.5 μm or less.

4. The electronic component according to claim 1, wherein
a total thickness of the first plating layer and the second plating layer is from 5.0 to 8.5 μm.

5. The electronic component according to claim 4, wherein
a ratio of a thickness of the first plating layer to a thickness of the second plating layer is from 2/3 to 8/9.

6. The electronic component according to claim 1, wherein
the second plating layer includes Sn.

7. The electronic component according to claim 1, wherein
the second plating layer includes from 0.1 to 0.5 mol% of S (sulfur).

8. The electronic component according to claim 1, wherein
the external conductor further includes a solder plating layer located on the third plating layer.
